(19) United States
(12) Patent Application Publication
(10) Pub. No.: US 2005/0190988 A1
(43) Pub. Date: Sep. 1, 2005

(54) Passive positioning sensors

(75) Inventor: Eric Feron, Cambridge, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: MASS INSTITUTE OF TECHNOLOGY (MIT), Cambridge, MA (US)

(21) Appl. No.: 10/790,506

(22) Filed: Mar. 1, 2004

(51) Int. Cl. G06K 9/36

(52) U.S. Cl. 382/291

(57) ABSTRACT

Methods and systems for determining position relative to an interference pattern generator including capturing an image of an interference pattern from a known fringe pattern generator with a viewer. The phase of the interference pattern is then determined with a processor and the phase information is used to find the orientation of the viewer relative to the fringe pattern generator. The distance to the fringe pattern generator is also found based on the interference pattern and position data relative to the fringe pattern generator is derived.

### BACKGROUND OF THE INVENTION

The invention relates generally to methods and apparatus for positioning or determining the position of an object by optical analysis.

Global positioning satellite (GPS) technology has become popular as a means for positioning. For example, GPS technology can be used by a pilot to find the position of his vessel at sea. Such positioning information can then be used for navigation, tracking, surveying, and locating functions. For example, the position of the vessel can be used to assist with tasks such as planning a future course, tracking other vessels, and locating or surveying underwater phenomenon. GPS systems are even offered in many automobiles to assist drivers with finding their way.

These GPS systems find a position by triangulation from satellites. A group of satellites provide radio signals which are received by a receiver and used to measure the distance between the receiver and the satellites based on the travel time of the radio signals. The location of the receiver is calculated using the distance information and the position of the satellites in space. After correcting for errors such as delays caused by the atmosphere, GPS systems can provide positioning data within about 16 meters.

Unfortunately, GPS technology has certain limitations. One of the difficulties with GPS systems is that they rely on receiving signals from satellites position in orbit. Obstructions can diminish, disrupt or even block the signals. For example, when a GPS unit is positioned in the shadow of a large building the number of satellite signals can be reduced, or even worse, the surrounding structures can completely block all satellite signals. Natural phenomenon, such as cloud cover and charged particles in the ionosphere can also reduce the effectiveness of GPS systems. In addition, some positioning tasks require greater accuracy than GPS technology can provide.

Other positioning systems include the use of local radio beacons which operate on similar principles to the GPS system, and laser positioning systems. Unfortunately, these systems rely on specialized and costly apparatus, and may also require careful synchronization and calibration.

As a result, there is a need for a simple and robust local positioning system which does not rely on orbiting satellites or local radio beacons, and which can provide increased positioning accuracy when needed.

### SUMMARY OF THE INVENTION

The present invention provides object positioning and attitude estimation systems based on an reference source, e.g., a grating assembly which generates a fringe interference pattern. The invention further includes a viewer, mountable on an object, for capturing an image of the fringe pattern. A processor can analyze the detected fringe pattern and, based thereon, the orientation of the object relative to the reference location is determined.

In one aspect of the invention, a method for determining position relative to an interference pattern generator is disclosed comprising capturing an image of an interference pattern from a known fringe pattern generator with a viewer and determining the phase of the interference pattern. Changes in phase information is then used to find the direction of the viewer's position relative to the fringe pattern generator. The distance to the plane supporting the fringe pattern generator is determined based on the number of fringes in the interference pattern. Based on this distance and orientation information, position data relative to the fringe pattern generator can be determined.

In another aspect of the invention, any integer ambiguity is resolved by tracking the phase of the interference pattern as the viewer changes in position relative to the fringe pattern generator. For each of the multiple phases captured by the viewer, the processor determines relative position data. Impossible or unlikely position data can then be removed. This position information can also be verified with information obtained from the geometry of the fringe pattern generator. For example, lights, reflectors, colored surfaces or other optical markers can be used to define a border or other predefined shape for acqusition of basic distance and/or orientation information.

In yet another aspect of the invention, position data is determined using the geometrical features of the fringe pattern generator. In one embodiment, projective geometry provides low-resolution position data based on the known geometry of the fringe pattern generator and the geometry of the fringe pattern generator in an image captured by the viewer. This position data is then combined with position data based on the fringe interference patterns to find high-resolution position data.

The geometrical features of the fringe pattern generator can also be used with a feature extraction algorithm to recover or reorient, e.g., to rectify, the image of the fringe pattern generator. The resulting image can then be analyzed to extract normalized data, thus simplifying position analyses.

### BRIEF DESCRIPTION OF THE DRAWINGS

The invention will be more fully understood from the following detailed description taken in conjunction with the accompanying drawings:

FIG. 1 is a schematic perspective view an interference pattern generator which can be used with the device of the present invention;

FIG. 1A is a side view of the interference pattern generator of FIG. 1;

FIG. 2 illustrates a grating assembly which can be used with the interference pattern generator of the present invention;

FIG. 2A illustrates another grating assembly which can be used with the interference pattern generator of the present invention;

FIG. 2B illustrates another grating assembly which can be used with the interference pattern generator of the present invention;

FIG. 3 illustrates another embodiment of the grating assembly of the present invention;

FIG. 3B illustrates another embodiment of the grating assembly of the present invention;

FIG. 4A illustrates one embodiment of the system of the present invention;

FIG. 4b illustrates the system of FIG. 4A arranged in a different position;

FIG. 5 illustrates another embodiment of the system of the present invention;

FIG. 6 illustrates spatial geometry calculations which can be used with one embodiment of the present invention;

FIG. 7 illustrates a top view of the embodiment shown in FIG. 6; and

FIG. 8 illustrates a side view of the embodiment shown in FIG. 6.

### DETAILED DESCRIPTION OF THE INVENTION

The present invention provides positioning systems and methods for determining a position in space, such as the location of an object. The system preferably includes a fringe interference pattern generator, a viewer for capturing an image of the fringe patterns (also known as “Moiré patterns”), and a processor for determine position based on the information gathered by the viewer. The processor can derive position data based on phase information gathered from the fringe patterns, as well as, position data based on the geometry of the fringe interference pattern generator.

Unlike prior art positioning systems which rely on signals from distant transmitters, the present invention allows a user to determine position with only a fringe interference pattern generator, a viewer, and a processor. For example, the system can be used inside a laboratory or warehouse where GPS measurements would be unavailable because the buildings block satellite signals. In addition, the system is easy to set up, can provide highly accurate positioning data, is inexpensive to operate, and is insensitive to electromagnetic interference. The present invention therefore provides a simple and robust positioning system that can assist with navigating, docking, tracking, measuring, and a variety of other positioning related functions.

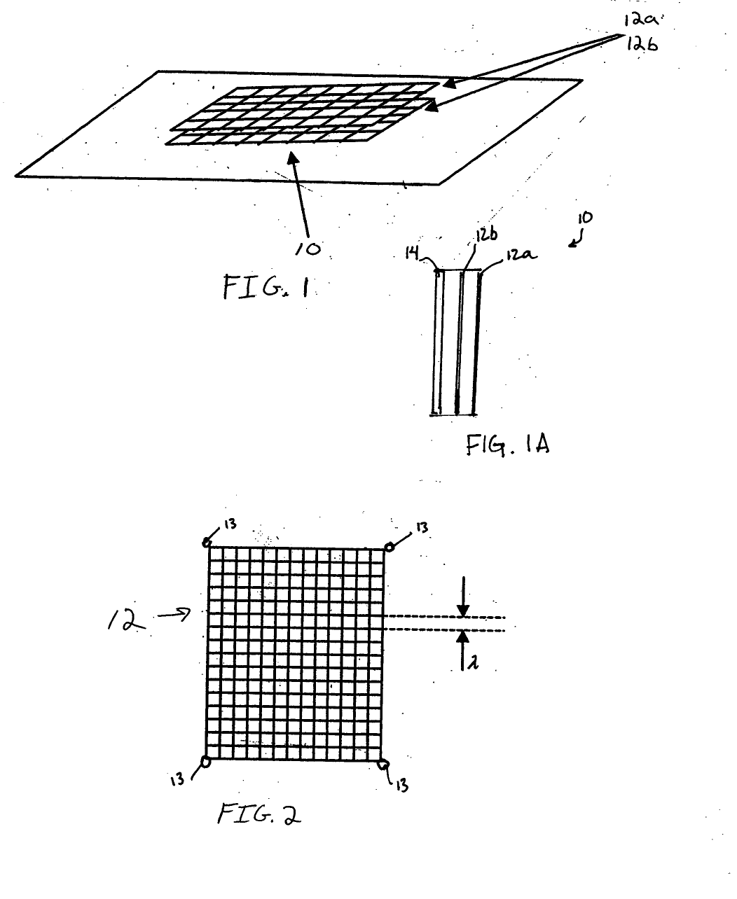

The system includes a fringe interference pattern generator, such as grating assembly 10 illustrated in FIGS. 1 and 1A. As shown, the grating assembly includes two parallel gratings 12a, 12b, which are preferably flat, and can be fixed a predetermined distance from one another. A person skilled in the art will appreciate that a variety of grating shapes can produce recognizable fringe interference patterns such as rectangular, circular, triangular, and irregular gratings. Although parallel gratings are the preferred source of fringe interference patterns, any interference pattern source capable of producing a recognizable interference pattern which changes with the viewpoint of the viewer can be used. The pattern generators can be entirely, or partially, passive insofar as only illumination by the viewer or ambient light is needed to generate the fringe pattern.

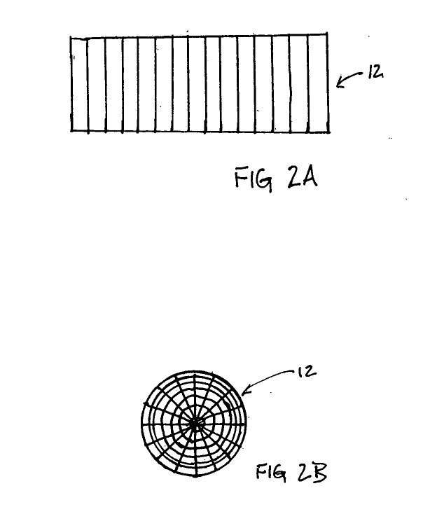

The characteristics of the interference pattern depend on the characteristics of the gratings used to generate the pattern. For example, the periodicity of the interference fringes, which is the distance between fringes, depends on the spacing of the gratings and the distance between the gratings. If the two gratings are regular and identical, periodicity can be calculated by P=hλ/d, where the variable h represents the distance from the viewer to the gratings, λ is the characteristic wavelength of the gratings, and d is the distance separating the two gratings. P is the geometrical distance between two consecutive fringes. λ is usually the mesh size of the gratings as shown in FIG. 2. By changing these variables, the interference pattern seen by the viewer can be changed.

FIG. 2 also illustrates the use of one or more alignment markers 13 which can assist in angular estimation and/or distance measurements. Four markers 13, e.g., LEDs or other light emitters or reflectors, define the border of the grating assembly. As discussed further below, determining the position of fringe pattern generator borders (typically as a trapezoidal image) can provide initial estimates of height, distance and/or angular orientation.

In FIG. 2A, another grating 12 is shown for generating a one-dimensional interference fringe pattern. Such one-dimensional systems are useful where the height of viewer/object is known and/or the object is operating on a flat surface (such as a warehouse floor). FIG. 2B illustrates yet another grating pattern in which the grating 12 is circular. The system of FIG. 2B is particularly useful in obtaining rotational information.

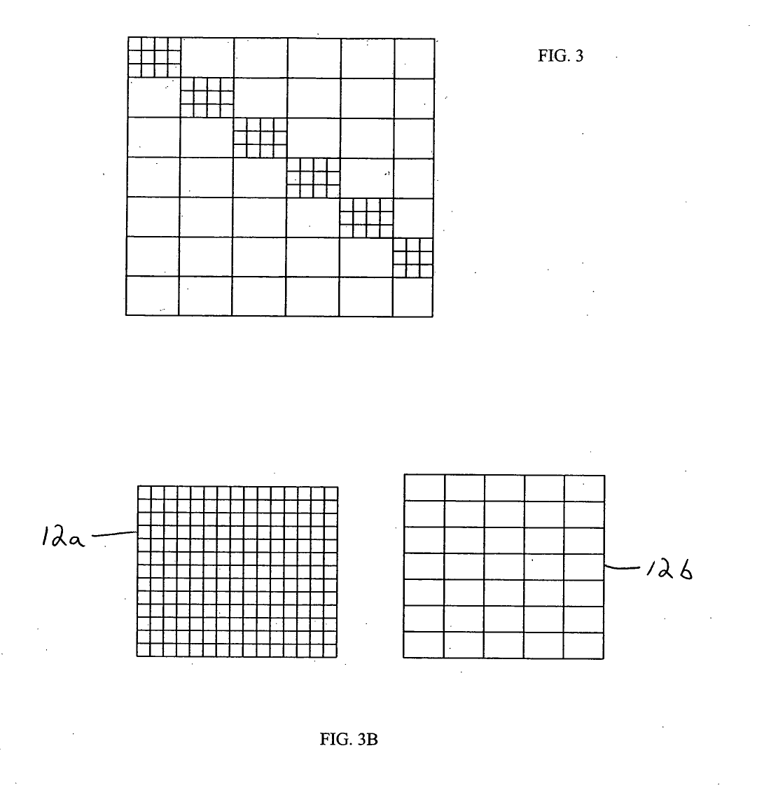

The periodicity of the gratings 12 are preferably matched to the scale and accuracy of the desired measurement. For measuring positions over a large area or where accuracy is less of a concern, a larger periodicity is preferred. Conversely, a smaller periodicity is preferred for smaller areas or for increased accuracy. In one embodiment, the fringe pattern generator can produce both large and small fringe interference patterns with gratings of varying mesh size. FIG. 3 illustrates one embodiment of a fringe pattern generator with two mesh sizes. The larger grating is defined by a mesh size λ, and the smaller gratings, optionally positioned within the larger grating, is defined by a mesh size of λ′. In use, the fringe pattern produced by the larger grating can provide rough position data, and when necessary, analysis of the fringe patterns produced by the smaller gratings can provide refined position data. For example, if the system were used with a vehicle traveling toward the gratings, the larger gratings could be used from a distance and the smaller gratings from up close.

In another embodiment shown in FIG. 3B, the fringe pattern interference generator 10 can have two gratings 12a, 12b each having different mesh sizes λ. Adjusting the mesh size of one grating with respect to the other grating amplifies or reduces the speed at which the fringe pattern changes with relative movement between the fringe pattern generator and the viewer. For example, by increasing the mesh density of the grating closer to the viewer (e.g., positioning grating 12a as the upper grating) relative to the grating further from the viewer, the speed at which the fringe pattern image changes can be increased. This may be desirable for measuring small movements and/or where the viewer and fringe pattern generator operate in a fixed plane.

The grating assemblies of the present invention can be illuminated in various ways. In one embodiment, ambient light illuminates the grating assembly and creates the interference pattern. Alternatively, the gratings may be backlit to make the interference fringes more distinct. The light chosen for illumination may be of any wavelength which can be acquired by the viewer of present invention, including visible light. Exemplary sources of radiation include visible, ultraviolet and infrared light. More generally, any electromagnetic radiation source capable of generating an interference fringe pattern can be employed. The term “light” as used herein is intended to encompass any such electromagnetic radiation.

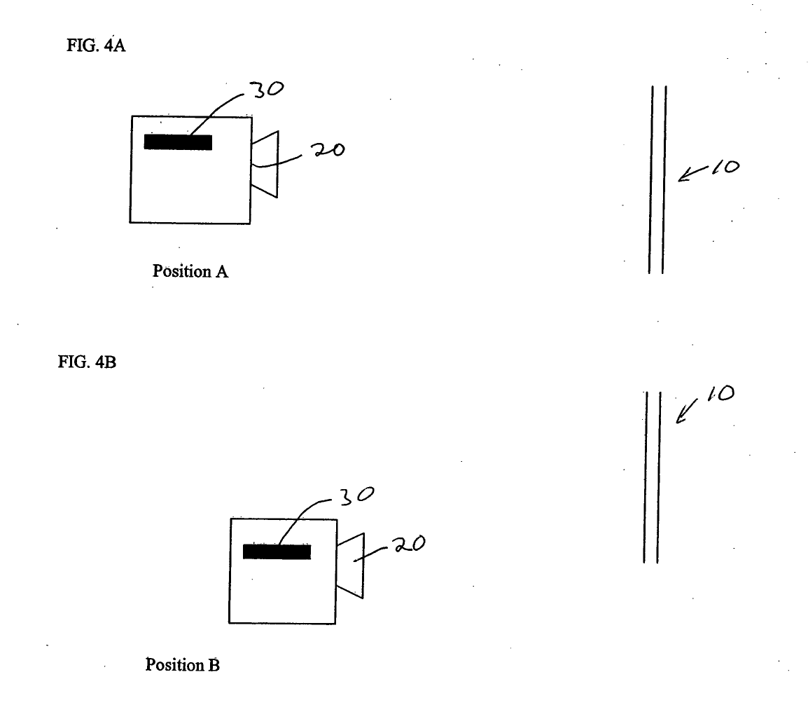

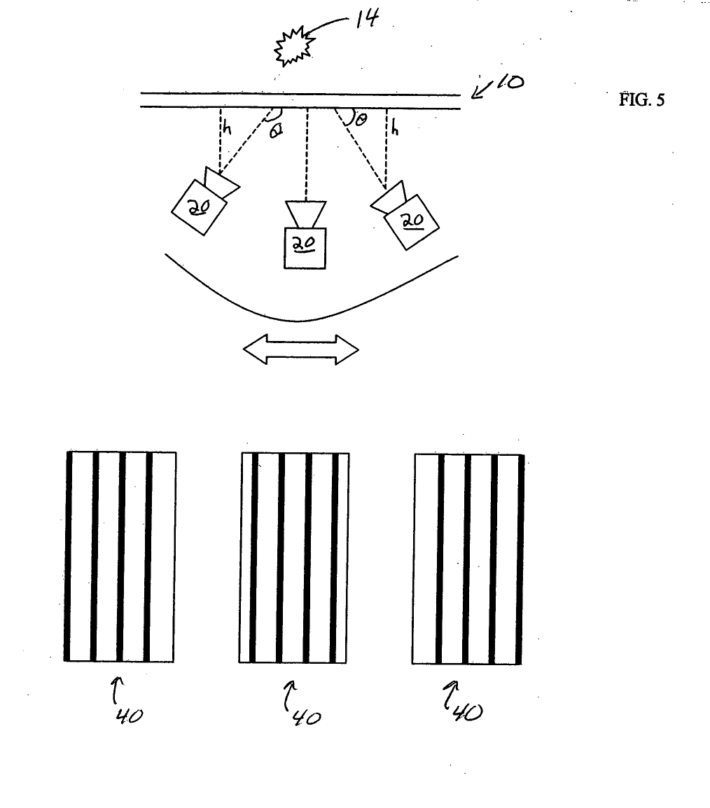

To assist with calculating position data, the grating can include a variety of markers. For example, a marker can be placed at a corner of one of the gratings; a preferred marker is a light having a distinct color or wavelength. A processor 30, shown in FIGS. 4A and 4B, can then use the marker to determine the grating assembly orientation, e.g., which side of the grating assembly image supplied by the viewer is the top side. Where the viewer may have some trouble distinguishing the interference pattern generator from a cluttered background, the marker can also help the viewer locate the interference pattern. A person skilled in the art will appreciate that the interference pattern generator can also be distinguished base on its shape, illumination, color, other characteristics, and/or combinations thereof.

One skilled in the art will appreciate that the grating assembly 10 can be scaled according to the intended use. For measuring very small movements, such as the movement of a person's skin in response to their heartbeat, the fringe pattern interference generator might cover an area smaller than a postage stamp. In other applications, such as assisting with docking of large vessels (e.g., cargo ships) the fringe pattern interference generator could cover an area hundreds of feet across.

The image of the interference pattern is preferably captured by a viewer 20 capable of acquiring data representing an image containing the fringe pattern and supplying the data to a processor 30. In one embodiment, the viewer 20 is a camera which can acquire images, preferably digital, of the scene containing the interference pattern generator. The camera preferably has a large enough angular aperture to detect the interference pattern generator (target) over a large range of locations, and to has enough resolution to detect the shape of the target. The choice of camera will depend on the wavelength of the radiation which creates the interference fringes. Exemplary cameras include IR cameras and most standard, commercially available, video cameras.

The processor 30 uses data from the viewer 20 to process the image of the grating assembly 10 and to obtain position data. The processor 30 preferably is capable of performing a variety of computations based on information from the viewer and information about the characteristics of the interference pattern generator. The calculations can include input from the viewer as well as stored information and/or information entered by a user. A person of skill in the art will appreciate that the processor can be a dedicated microprocessor or chip set or a general purpose computer incorporated into the object whose location is to be determined, or a similar but remote dedicated microprocessor or general purpose computer linked to viewer by wireless telemetry.

FIGS. 4A and 4B illustrates the grating assembly 10, camera 20, and processor 30. From position A shown in FIG. 4A, the camera 20 receives the interference pattern generated by the grating assembly 10. The processor 30 can then determine the relative position based on the image received. The relative position refers to position information based on the direction and distance from the grating assembly. If desired, the global position can then be determined based on the position of the grating assembly. As shown in FIG. 4B, the camera has moved to position B. Again, the processor can be used to determine the position of the camera with respect to the grating assembly. Alternatively, the processor can track the movement of the camera from position A to position B based on the images received by the camera during transit.

Although this example is given in terms of finding the position of the camera 20, the processor 30 can also calculate the relative position of a point in space or an object. For example, the camera could be mounted on an object, such as a vehicle, and the processor could be used to determine the position and/or orientation of the object. The position of the object can be calculated by the processor directly, or stepwise based on the relative position of the grating assembly to the camera, and the camera to the object.

The processor 30 can use the images it receives to determine position in several ways. In one embodiment, the processor determines the phase of the interference pattern, determines the number of fringes, and derives position data. Phase information is useful because as the viewer changes the angle with which it views the grating assembly, the interference pattern which it captures changes phase. Since the relationship between the change in phases and the viewing angle is known, the processor uses the phase information to help determine position. FIG. 5 shows the grating assembly 10 with backlighting 14 and viewer 20 positioned at three different viewing angles (θ). The three vertical fringe pattern images 40 illustrate exemplary fringe patterns corresponding to the three viewing positions of the viewer 20. Based on these images 40, the processor 30 can find phase information and determine the angle (e.g., θ) at which the viewer is positioned relative to the grating assembly. Where the viewer and the grating assembly are positioned on different planes, the angle θ is a measurement of the orientation of the viewer on the plane containing the viewer, which is parallel to the plane supporting the grating assembly

In the case when the gratings are regular and identical, the phase of the interference fringe pattern is equal to 2πδ/(λ tan θ)+2kπ, where d is the distance between gratings, λ is the characteristic wavelength of the gratings, k is an unknown integer, and θ is the phase angle or viewing angle. The unknown integer is a result of the fringe pattern cycling through several phases as the viewing angle varies from 0° to 180°. Apart from the integer ambiguity, it is possible to obtain the viewing angle based on known information about the interference pattern generator and the phase of the interference pattern.

In FIG. 5, the fringe patterns 40 are shown as only having vertical fringes. An actual interference pattern would preferably have horizontal and vertical fringes so that a horizontal and vertical angle can be determined. Thus, by solving for the horizontal and vertical viewing angles the orientation of the viewer can be determined, up to an integer ambiguity, with respect to the grating assembly.

The interference pattern also allows the processor 30 to determine h, the distance between the viewer and the plane supported by the interference pattern generator. This distance can be found by determining the total number of fringes. Then with the known dimensions of the gratings, the wavelength of the fringes can be determined based upon the formula, wavelength=width of the grating/number of fringes. The variable h can then be solved for since the wavelength of the fringes is equal to hλ/d and λ and d are known characteristics of the grating assembly.

To find more exact position data and resolve the integer ambiguity, tracking of the phases of the interference fringes can be combined with an algorithm for eliminating nonsensical or unlikely choices. For example, standard maximum likelihood estimation algorithms can be used to lift the integer ambiguity and obtain precise positioning data. The idea is to combine high-accuracy (up to an integer ambiguity), relative position information provided by the fringes of the pattern generator with low-accuracy, absolute position information provided by a standard position estimation algorithm using only the geometrical features of the interference pattern generator and thereby resolve the integer ambiguity. A feature extraction algorithm based on the geometrical features of the interference pattern generator can recover and reorient the target (pattern interference generator), and obtain a low-resolution estimate on the position and orientation using stored information concerning the geometry of the target, the characteristics of the viewer, and data from the viewer. Exemplary stored information can include the dimensions of the target, e.g., rectangular with given edge lengths, and minimal information about the camera, e.g., the angular aperture of the camera.

In one embodiment, an algorithm based on projective geometry, combined with a priori knowledge of the shape of the target and its dimensions, is used to obtain a rough estimate of the absolute position and orientation of the viewer with respect to the target. The position and orientation of the target with respect to the viewer can be summarized by a measurement consisting of a most likely estimate P_{g,k}=(x_{gk},y_{gk},h_{gk}), along with a probability distribution around this most likely estimate. The coordinates x_{gk} and y_{gk} are the planar coordinates of the viewer with respect to the target, and h is the distance to the plane supported by the target. Preferably, the uncertainty estimate is simplified in the form of a covariance matrix C_{gk}. In this notation, k designates the time step at which the camera captures the image. Using the rough position and orientation information, the picture of the target (including interference fringes) is preferably “rectified”, to provide an orthonormal view of the target. The process for rectifying an image of the target is discussed in detail below.

Once the target is rectified, the fringes on the target can be more easily analyzed. The fringes appear as periodic pattern in two dimensions. Counting the number of fringes within the frame yields a new estimate of the altitude h_{fk} of the target. Looking at the phase of the fringes (both horizontally and vertically) can yield a new estimate on the position of the viewer with respect to the target, up to an integer ambiguity. It can also help refine the orientation of the viewer with respect to the target. The most standard algorithms to perform this step are the 1-D and 2-D Fast Fourier Transforms (FFTs).

This second step provides another, independent measurement of the position and orientation of the target; it can be summarized by a family of most likely estimates P_{f,k,j,i}=(x_{fk}+jl,y_{fk}+il,h_{fk}), on the position. The index k designates the time step at which the camera captures the image. The indices j and i are signed integer numbers and 1 the apparent wavelength of the interference pattern on the target, along with the same probability distribution centered on each most likely estimate, usually summarized by a covariance matrix C(P_{f,k}) (here it is assumed that 1 is the same in both dimensions, corresponding to equal grating wavelength in both dimensions). In addition, for each pair (j,i), we associate a positive probability pⱼᵢ for the corresponding candidate position P_{f,k,j,i} to be the true position. Thus the sum over all indices i and j of the probabilities pᵢⱼ must be equal to one.

Thus two sets of position data are available at all time steps k: First a set of absolute positions and covariances on positions (P_{g,k}, C(P_{g,k})) obtained through direct processing of the target via projective geometry considerations, and a family of positions, covariances on positions and probabilities (P_{f,k,j,i}, C(P_{f,k}), pⱼᵢ), obtained from processing the interference patterns from the target.

The final position estimate can be determined by combining the measurements. In one embodiment, weighted averages can be used to determine a most likely position and orientation estimate Pₖ for the target along with its covariance C(Pₖ). This information can then be made available to the user. A person skilled in the art will appreciate that a variety of algorithms can be used to obtain the most likely estimate, including, by way of non-limiting example, Bayesian and Kalman filtering techniques, and derivatives such as particle filtering, Wiener filtering, Belief networks, and in general any technique aimed at inferring high-precision information from the optimal combination of a set of complementary observations.

In an alternative embodiment, a different algorithm for determining position can be used. First and again, an algorithm based on projective geometry is used alone, combined with a priori knowledge of the shape of the target and its dimensions, to obtain a rough estimate of the absolute position and orientation of the viewer with respect to the target. The position and orientation of the target with respect to the viewer can be summarized by a measurement consisting of a most likely estimate P_{g,k}=(x_{gk},y_{gk},h_{gk}), along with a probability distribution around this most likely estimate.

Second, the target can be rectified and the fringes on the target can be analyzed. This second step provides another, independent measurement of the position and orientation of the target; unlike the first exemplary algorithm, in this case we use the target as a very precise means to obtain velocity information on the potion of the viewer relative to the target (along with, again, an independent peasurement of distance h to the plane supported by the target), which we denote V_{f,k}=(vx_{fk},vy_{fk},h_{fk}). The index k designates the time step at which the camera captures the image. vx and vy respectively denote the velocities along the two x- and y-axes in the plane supported by the target.

The two sets of complementary information are available at all time steps k: First a set of absolute positions and covariances on positions (P_{g,k}, C(P_{g,k})) obtained through direct processing of the target via projective geometry considerations, and a set of velocities (with associated covariance) and vertical position, obtained by processing the interference patterns from the target.

The final position estimate can be determined by combining the measurements, using, for example, nonlinear filtering techniques. One such filter to obtain precise estimates on x and y could be constructed as follows: Let (xₑₛₜ,yₑₛₜ,hₑₛₜ) be the estimated position in the plane supported by the target.

Initialize the estimated position by reading the position measurement P_{g,0}=(x_{g0},y_{g0},h_{g0}); (x_{est,0}, y_{est,0},h_{est,0})=(x_{g0},y_{g0},h_{g0}). If (x_{g0},y_{g0},h_{g0}) is unavailable, set (x_{est,0}, y_{est,0},h_{est,0})=(0,0,0).

Update the position estimate x_{est,k+1}:=x_{est,k}+vx_{fk}+Lₓ(k)(x_{gk}−x_{est,k})
y_{est,k+1}:=y_{est,k}+vy_{fk}+L_{y}(k)(y_{gk}−y_{est,k})
i h_{est,k+1}=h_{est,k}+L_{h,1}(k)(h_{gk}−h_{est,k})+L_{h,2}(k)(h_{fk}−h_{est,k})

Set k:=k+1 and return to step 2)

In this algorithm, the gains Lₓ(k), L_{y}(k), L_{h,1}(k) and L_{h,2}(k) are functions of time and allows the filter to weigh in the absolute (but noisy) position measurement obtained from the geometric position estimate into the overall position estimate. Typically these gains should be larger at the beginning of the algorithm, or when it needs to be reset, so that the position estimate quickly converge to the geometric position estimate. For large values of k, the value of the gains Lₓ(k), L_{y}(k), should then be decreased (but never set to zero), corresponding to a higher reliance on the velocity estimates obtained from the interference fringes. Other rules of thumb include using larger values of Lₓ(k), L_{y}(k), when the viewer is not facing the target (θ close to 0 or 180 degrees) and using smaller values of Lₓ(k), L_{y}(k), when the viewer is facing the target (θ close to 90 degrees). Optimal values of Lₓ(k), L_{y}(k), L_{h,1}(k) and L_{h,2}(k) can be obtained by using Extended Kalman filtering techniques.

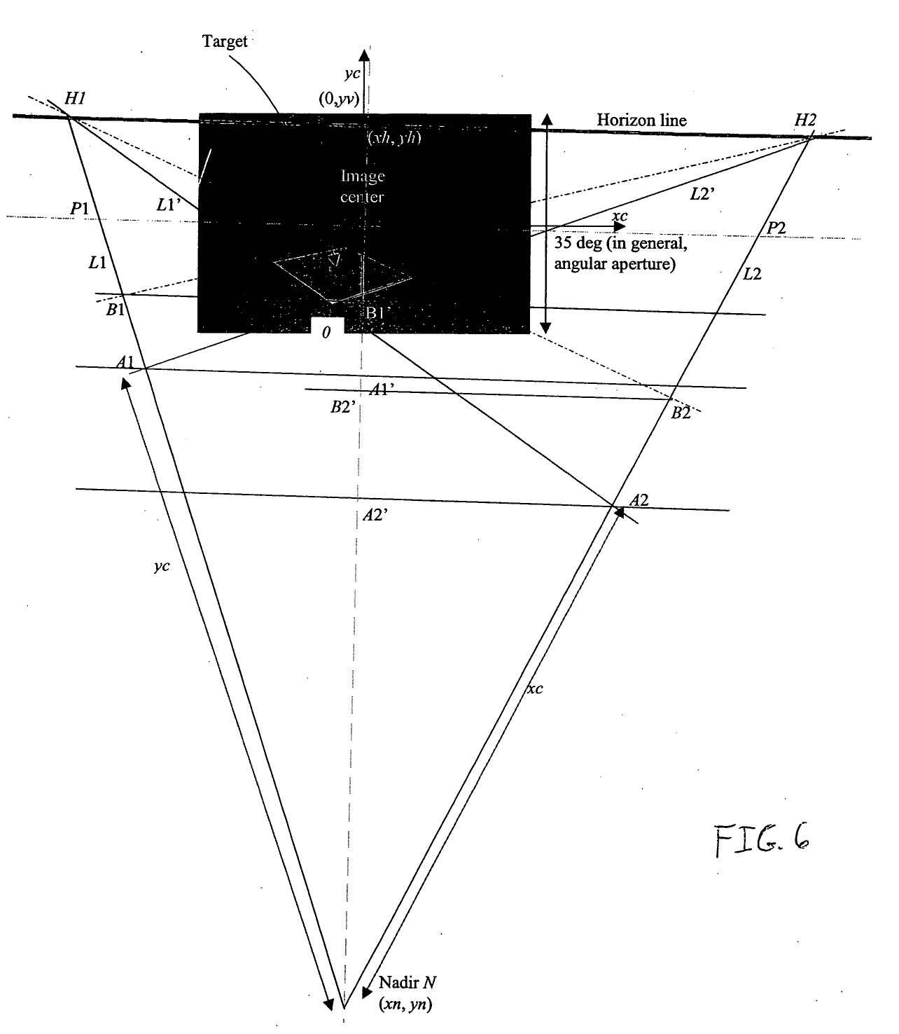

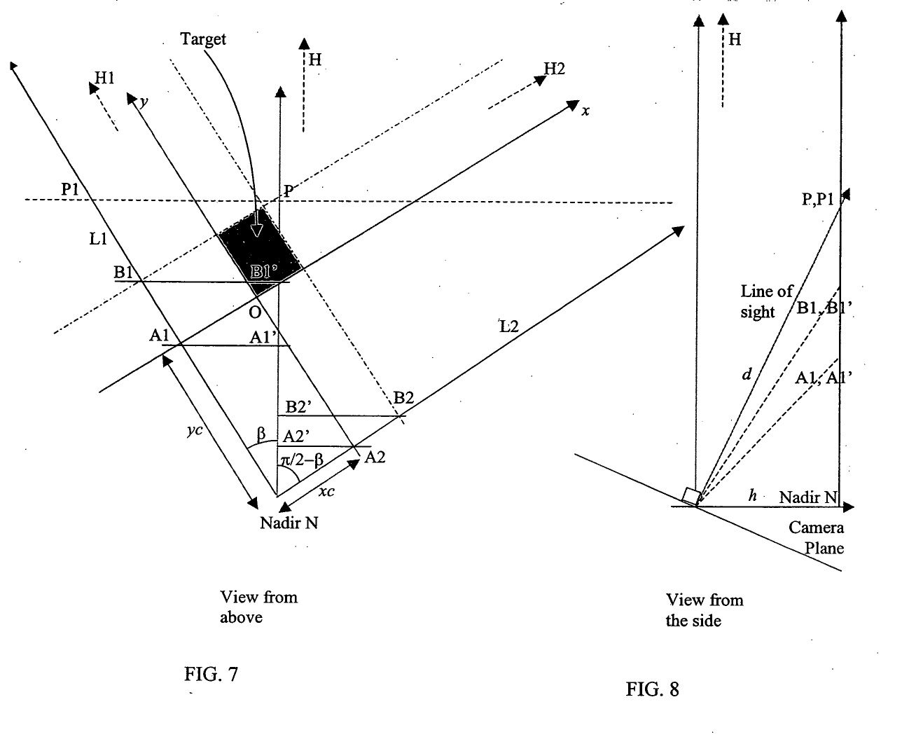

FIGS. 6, 7, and 8 illustrate a square fringe pattern generator of known dimensions which appears as a rectangle because of the viewer's perspective. Rectifying the image of the fringe pattern interference generator provides a view of the interference pattern in actual dimensions on the horizontal plane. The following description exemplifies the procedure for (i) obtaining absolute position (and attitude) measurements (x_{gk},y_{gk},h_{g0k}) and (ii) rectifying the fringe pattern generator.

The position of the four corners of the target are first identified in camera coordinates. One corner is assumed to be the origin and denoted in by 0. The position of the horizon line is then computed. The horizon line contain two points, the intersection of the first two parallel edges of the camera target, and the intersection of the second two parallel edges of the camera target, denoted H1 and H2 in FIG. 6.

Next the location of the nadir is found. The nadir N is located on the center line passing through the center of the camera image and orthogonal to the horizon line. The nadir location is necessarily 90° away from the horizon lines. Let f be the (known) focal length of the camera. Then, angular coordinates of any point P with coordinates x,y may be measured on the image plane, away from the center of the camera as follows:
α_{P}=atan(sqrt(x²+y²)/ƒ) (1)
where ‘sqrt’ is the square-root function. Let H=(xh, yh) be the intersection of the horizon line with the center line. The corresponding angular coordinate is
α_{H}=atan(sqrt(xh²+yh²)/ƒ) (2)

Then the position of the nadir N, (xn, yn) in the figure coordinates is
(xn, yn)=(xh, yh) ƒtan(α_{H}−π2)/sqrt(xh²+yh²). (3)

The line L1 going from N to H1 is parallel to that going from 0 to H1 in three dimensions and the line L2 going from N to H2 is parallel to that going from 0 to H2 in three dimensions. In addition, these lines are orthogonal to each other (in three dimensions). Thus measuring the three dimensional distance from L2 to L2′ gives the y coordinate of the viewer. Let A1′ be the intersection of the center line with the line passing through A1 and parallel to the horizon line. From (1), the angular position of A1′ is
α_{A1′}=atan(sqrt(x_{A1′}+y_{A1′}²)/ƒ) (4)

Thus the distance of A1 from the Nadir N is h cot(−α_{A1′}+α_{H})

Consider now P1, the intersection of a line parallel to the horizon line going through the center of the picture with L1. From (1) the angular coordinate of P1 is
α_{P1}=atan(sqrt(x_{P1}²+y_{P1}²)/ƒ) (5)

We now compute the position of P1 on the plane supported by the target. The projection of the center of the image to that plane is located at a distance
d=h/sin α_{H} (6)
from the camera. The point P1 is located at a distance d tan α_{P1} from the projection of the center of the camera onto the plane supported by the target. The distance from the nadir to the projection of the center of the camera onto the plane supported by the target is d cos α_{H}.

Thus the angle β of the line from the nadir to point P1 with the line from the nadir to the projection of the center of the image to the plane supported by the target is given by
tan β=d tan α_{P1}/(d cos α_{H})=tan α_{P1}/cos α_{H} (7)

Remember the distance form the Nadir to the point A1′ is
h cot(−α_{A1′}+α_{H}), (8)
we finally get the distance yc from the nadir to A1 as
yc=h cot(−α_{A1′}+α_{H})/cos β. (9)
and this is one of the coordinates sought.

Because of the rectangular shape of the target, the line going from the nadir to A2′ is at an angle π/2−β from the line from the nadir to the projection of the center of the image onto the plane supported by the target. Thus the distance xc from the nadir to A2 is
xc=h cot(−α_{A2′}+α_{H})/sin β, (10)
where
α_{A2′}=atan(sqrt(x_{A2′}²+y_{A2′}²)/ƒ). (11)

Thus we now have the sought coordinates xc and yc, up to the unknown height h. To get this height, we can perform exactly the same operation to compute the distance (xc′,yc′) from the nadir to the points B1 and B2, respectively. For example,
xc′=h cot(−α_{B2′}+α_{H})/sin β, (12)
where
α_{B2′}=atan(sqrt(x_{B2′}²+y_{B2′}²)/ƒ). (13)

Using the known relationship
xc′=xc+L (14)
where L is the length of the side of the target, we get

h cot(−α_{B2′}+α_{H})/sin β−h cot(−α_{A2′}+α_{H})/sin β=L, (15)
or
h=L sin β/(cot(−α_{B2′}+α_{H})−cot(−α_{A2′}+α_{H})). (16)

Thus we now have all the desired information. Absolute position measurements are obtained by setting: x_{gk}=xc, y_{gk}=yc, h_{gk}=h

These equations can be used to correct the orientation of the reference target image to that it is viewed in actual dimensions on the horizontal plane. This makes it easy to pick the Fourier transform of the interference image to obtain high resolution information on relative position changes.

Position data can also be calculated without the step of rectifying the image. Although the image of the interference pattern generator may be skewed by the viewer's perspective, the viewer can still use the image to determine relative position.

The high resolution positioning information provided by the present invention can be used in a variety ways, including by way of non-limiting example, navigating, docking, tracking, and measuring. For example, the system can be used inside a warehouse to track packages as they move between locations, to assist with alignment during docking, and/or to guide automated machinery. In a laboratory, the present invention could provide inexpensive, but accurate measurements for conducting experiments. Other possible uses may include medical monitoring and tracking. For example, an interference pattern generator could be placed on a patient to monitor breathing and/or heartbeat. Another medical example would include using the present invention to monitor patient movement during delicate surgery, such as, brain surgery. If the patient were to move, the highly accurate positioning system of the present invention could alert doctors and/or provide a surgeon with guidance for making adjustments. A person skilled in the art will appreciate that the present invention can be used to perform a variety of functions in a variety of industries.

A person skilled in the art will also appreciate that the foregoing is only illustrative of the principles of the invention, and that various modifications can be made by those skilled in the art without departing from the scope and spirit of the invention. All references cited herein are expressly incorporated by reference in their entirety.

1. An object positioning and attitude estimation system, comprising:
a grating assembly associated with a reference location, which generates a fringe interference pattern;
a viewer mountable on an object for capturing an image of a fringe pattern generated by the grating assembly; and
a processor in communication with the viewer for measuring the generated fringe pattern and, based thereon, determining the orientation of the object relative to the reference location.

2. The system of claim 1, wherein the grating assembly comprises at least two planar gratings in a fixed spatial relationship to each other.

3. The system of claim 2, wherein the grating assembly includes gratings of different properties.

4. The system of claim 1, wherein the grating assembly further comprises a light source.

5. The system of claim 4, wherein the light source is a visible light source.

6. The system of claim 1, wherein the grating assembly relies on ambient light.

7. The system of claim 1 wherein the system includes at least one optical marker to provide a rough estimate of distance and orientation.

8. The system of claim 7 wherein the optical marker defines a border around the pattern generator.

9. The system of claim 7 wherein the system includes one or more corner markers.

10. The system of claim 7 wherein the marker provides reference information for rectification of the fringe pattern data.

11. The system of claim 1, wherein the grating assembly includes portions having different mesh sizes.

12. The system of claim 11, wherein the grating assembly includes a top grating having a smaller mesh size than a bottom grating.

13. The system of claim 11, wherein the grating assembly includes adjacent portions having different mesh sizes.

14. The system of claim 1, wherein the viewer comprises a camera.

15. The system of claim 1, wherein the processor comprises an image processor that determines the orientation of the interference pattern, determines the distance to the pattern emitter, and extracts the phase of the interference pattern.

16. A method of determining position relative to a interference pattern generator, comprising capturing an image of an interference pattern from a known fringe pattern generator with a viewer;
determining the phase of the interference pattern with a processor;
using the phase information to find the orientation of the viewer relative to the fringe pattern generator;
determining the distance to the fringe pattern generator based on the number of fringes in the interference pattern; and
determining position relative to the fringe pattern generator.

17. The method of claim 16, wherein the phase of the interference pattern is tracked as the viewer changes in position relative to the fringe pattern generator

18. The method of claim 16, wherein a likelihood estimation algorithm is used by the processor to lift the integer ambiguity.

19. The method of claim 16, including determining the position of a horizon line in the image.

20. The method of claim 18, wherein the location of nadir in the image captured by the viewer is determined.

21. The method of claim 20, wherein the processor determines the angular coordinates on the image plane.

22. The method of claim 21, wherein the equations
yc=h cot(−α_{A1′}+α_{H})/cos β.
xc=h cot(−α_{A2′}+α_{H})/sin β,
h=L sin β/(cot(−α_{B2′}+α_{H})−cot(−α_{A2′}+α_{H})).
are solved by the processor and xc, yc, and h are used to correct the orientation of the reference target so that it is viewed in actual dimensions.

23. The method of claim 22, wherein the corrected image is used to determine phase information.

24. The method of claim 22, wherein the equations are used to estimate position data.

25. The method of claim 24, wherein the position data is used to resolve integer ambiguity.

26. Apparatus for determining position, comprising
a digital processor capable of receiving a digital picture of a fringe pattern from a camera,
the processor adapted to determine the phase of the fringe pattern based on the digital image, determine the distance between the camera and the fringe pattern source based on the number of fringes in the pattern, and find the relative position of the camera based on the position of the fringe pattern source.

27. A system for determining the position of a vehicle in three dimensions, comprising:
a known surface including two generally parallel gratings;
a passive detector for detecting interference fringe patterns created by the known surface; and
an image processor which receives the output from the passive detector and uses the output to determine the phase of the interference pattern created by the parallel gratings.

28. A pattern generating navigation aid comprising
a grating assembly associated with a reference location, which generates a fringe interference pattern upon illumination, the grating assembly further comprising at least two planar gratings in a fixed spatial relationship to each other; and
a source of illumination. A method of determining orientation of an object relative to a reference plane, comprising
mounting a grating assembly at a reference location, the grating assembly comprising at least two planar gratings in a fixed spatial relationship to each other;
illuminating the grating assembly to generate an interference fringe pattern;
imaging the fringe pattern;
measuring the phase of the fringe pattern with a detector mounted to the object; and
determining the orientation of the object relative to the reference location based on phase measurements.

29. A method of determining location of an object relative to a reference location, comprising
identifying a source associated with a reference location, the source generating an interference fringe pattern,
extracting geometric information from the source,
rectifying an image of the fringe pattern based on the geometric information,
determining the location of the object relative to the reference location based on the geometric information and phase measurements.

30. The method of claim 29 wherein the method further comprises estimating an altitude of the object relative to source based on geometric data.

31. The method of claim 29 wherein the method further comprises estimating an angular orientation of the object relative to a plane defined by the source based on geometric data.

32. The method of claim 29 wherein the method further comprises estimating distance based on the geometric data.

33. The method of claim 29 wherein the method further comprises refining a distance measurement based on a measurement of fringe spacing.

34. The method of claim 29 wherein the method further comprises refining an estimate of oreintation of the object relative to source based on phase changes in the fringe pattern over time.

35. The method of claim 29 wherein the method further comprises determining location based on a combination of geometric and phase data in which a weighting function is applied to at least one of the geometric or phase measurements over time.
